(19) United States
(12) Patent Application Publication
(10) Pub. No.: US 2005/0222769 A1
(43) Pub. Date: Oct. 6, 2005

(54) Modular sensor system

(76) Inventor: Jefferey Simon, Snellville, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/877,282

(22) Filed: Jun. 25, 2004

Related U.S. Application Data
(60) Provisional application No. 60/483,295, filed on Jun. 26, 2003.

(51) Int. Cl. G06F 7/00

(52) U.S. Cl. 701/300; 701/2

(57) ABSTRACT

A modular sensor system and method of use thereof, wherein sensing modules may be removably secured to a moving object in order to enable the detection of obstacles within the path thereof, and wherein detection of an obstacle results in the transmission of an alert signal to a remote receiver.

### FIELD OF THE INVENTION

The present invention relates generally to sensor technology, and more particularly, to a modular sensor system and method of use thereof, wherein sensing modules removably secured to a moving object detect the presence of obstacles within the path thereof and transmit an appropriate notification signal in response to said detection. The present invention is particularly suited for, although not limited to, use as an aircraft ground movement safety system, wherein modular sensors are installed onto an aircraft and a receiver is carried by a tug operator, thereby enabling sensory detection of approaching obstacles and automated advance warning to the tug operator in order to effectively reduce and/or eliminate ground collision damage.

### BACKGROUND OF THE INVENTION

Sensor systems are utilized in many industries for many applications. In particular, a variety of sensor systems have been borne out of a need for obstacle detection in order to avoid undesirable collisions. Aircraft, for example, have a variety of systems available, including radar, Doppler, sonar, and visual sensor systems, for identification and avoidance of potential airborne collisions.

Unfortunately, such airborne collision avoidance systems are largely ineffectual once the aircraft has landed, wherein although the threat of mid-air collision has abated, costly property damage can occur during ground movement due to accidental impact with another aircraft, vehicle and/or structural obstacle, such as a terminal building or structure. Complex sensor systems using, for example, radar and microwaves have been developed, wherein major airport facilities are able to track and/or map ground movement of vehicles. Such systems rely upon a central monitoring station, typically positioned in the tower. Traffic flow management is thus possible; however, specifically individualized and/or direct vehicle monitoring/notification with respect to any and all potential obstacles is virtually impossible.

Individualized sensor systems are available for obstacle detection during ground movement of vehicles. However, these systems are not readily adaptable for installation on fleets of individual aircraft. For example, self-guided vehicles involved in automated material handling, transportation and manufacturing operations are reliant upon sensors in order to avoid collisions that can effectively shut down such operations, resulting in a costly loss of production. Such self-guided vehicle sensors typically include lasers and other reflective light systems that involve generally complex installation within an essentially closed environment, wherein dedicated targets must be mounted at specific obstacle locations in order for such systems to be operable. Systems reliant upon dedicated targets within a specific area are obviously not readily adaptable for use in aircraft ground movement, wherein such movement occurs in a variety of locations and with an assortment of potentially moving and non-moving obstacles.

For traditional land vehicles, such as automobiles, similar sensor systems have been adapted to assist in parking, wherein installation of a sensory target within a garage is possible. However, when a vehicle travels to a remote location away from the sensory target, no benefit can be realized. Thus, on-board sensors have been developed and installed for use with a variety of vehicles, such as automobiles, boats and trains, whereby obstacles in the path of a mobile vehicle can be detected and avoided. One such device involves permanent installation of a microwave radar device to the rear bumper of a car, wherein the Doppler shift principle is utilized to detect potential obstacles within a given range and a warning is issued to the driver. These dedicated devices can be effective and could theoretically be installed for use on aircraft during ground movement. However, notification to the pilot of an impending obstacle is generally ineffectual, wherein the aircraft movement is controlled by a tug operator during ground movement. Additionally, such dedicated sensory electronics are unlikely to readily facilitate adaptation to changes in environmental parameters, or influences, such as variations in traffic levels and changes in airport conditions, such as visibility. Further, the cost of funding an installation of dedicated sensory electronics onto each individual aircraft in order to avoid the expense of property damage from potential ground movement collisions could be disadvantageous, especially for smaller privately owned planes.

Therefore, it is readily apparent that there is a need for a modular sensor system and method of use thereof, wherein the preferred sensing modules can be removably secured to a moving object, such as an aircraft, and can be selectively placed and/or configured based upon environmental characteristics and/or other requirements, wherein the sensing modules can detect the presence of obstacles within the path of the aircraft, wherein a signal, or alarm, can be transmitted following the detection of such an obstacle, and wherein the sensing modules can be quickly and easily transferred for use on another aircraft or moving object, thereby enabling an effective and specific method for avoiding obstacles during ground movement without requiring permanent equipment installation, and avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a modular sensor system and method of use thereof, wherein, in the preferred embodiment, sensing modules may be removably secured to a moving object in order to enable the detection of obstacles within the path thereof, and wherein detection of an obstacle results in the transmission of an alert signal.

According to its major aspects and broadly stated, in its preferred form, the present invention is a system and method for increasing the safety of aircraft ground movement, thereby reducing incidence of collisions and associated damage to general, corporate, and military aircraft, and other property, wherein sensors are provided within modular units having quick install/release mechanisms to enable temporary, secure placement on an aircraft, wherein the sensors are adapted to identify potential moving and/or stationary obstacles within a selected range of distance, wherein a transmitter is provided to send a warning signal from the sensor, and wherein a remote receiving unit is provided to receive the signal announcing the presence of an obstacle in order to enable appropriate evasive actions.

More specifically, the device of the present invention in its preferred form is a collision avoidance system comprising a plurality of modular sensor components and a remote receiver unit, wherein each sensor module is adapted to interchangeably mount to virtually any surface of a moving object via a unique clamping-type arrangement, the sensor is positioned within an adjustable probe adapted to be flexibly directed in virtually any direction relative to the mounting surface in order to detect an obstacle within a predetermined area relative to the moving object, and the modular sensor component is adapted to transmit an automated notification of such detection to the remote receiver. In the preferred form, the sensor utilizes ultrasonic Doppler techniques for obstacle detection, however, any suitable sensory equipment could be utilized, such as, for exemplary purposes only, laser, microwave, radar, vision, infrared, near-infrared sensors and/or any appropriate combination thereof, wherein advance detection and warning of potential collisions would be enabled.

The collision avoidance system of the present invention can be utilized with one or more modular sensor components, wherein the number of mounted sensor modules is proportional to the obstacle detection area. That is, placement of two sensor modules, wherein one sensor probe is directed toward the front of the vehicle and wherein one sensor probe is directed toward the rear of the vehicle, enables simultaneous obstacle detection in two opposing directions. Thus, inclusion of more sensor modules facilitates the creation of a full, three-dimensional, essentially spatially surrounding detection zone around the vehicle. Additionally, the notification system preferably provides a graduated response based upon estimated distance-to-impact with a potential obstacle, wherein the audible alert progresses from a warning signal to an alarm.

A feature and advantage of the present invention is the ability of such a system and method to provide obstacle detection sensors capable of modular implementation.

Another feature and advantage of the present invention is the ability of such a system and method to improve aircraft ground movement safety by enabling temporary installation of obstacle sensor/warning transmitters onto an aircraft, wherein such sensor/transmitters are capable of directly communicating a warning signal to an individual controlling the ground movement of the aircraft.

Another feature and advantage of the present invention is the ability of such a system and method to enable sensory detection of approaching obstacles and automated advance warning in order to effectively reduce and/or eliminate ground collision damage to a moving object.

Still another feature and advantage of the present invention is the ability of such a system and method to be interchangeably utilized on a plurality of moving objects, thereby enabling adaptive configurability relative to environmental conditions.

Another feature and advantage of the present invention is the ability of an alternate embodiment of such a system and method to incorporate fixedly installed obstacle sensor/warning transmitters onto an aircraft, wherein such sensor/transmitters are capable of directly communicating a warning signal to an individual controlling the ground movement of the aircraft.

Yet another feature and advantage of the present invention is the ability of such a system and method to directly monitor potential obstacles for a particular vehicle without requiring third-party or central station monitoring.

Still yet another feature and advantage of the present invention is the ability of such a system and method to be readily and economically adapted for interchangeable use on a plurality of individual aircraft.

Another feature and advantage of the present invention is the ability of such a system and method to detect potential obstacles without requiring dedicated or fixed position sensory target installation.

Still another feature and advantage of the present invention is the ability of such a system and method to be implemented without prohibitive capital expenditures.

Yet another feature and advantage of the present invention is the ability of such a system and method to effectively reduce incidence of collisions and associated damage to general, corporate, and military aircraft and other property during ground movement and during transfer into and out of hangars, maintenance facilities, or the like.

Still yet another feature and advantage of the present invention is the ability of such a system and method to enable adaptation of modular sensor units to virtually any surface, essentially irrespective of the surface manufacture materials.

Another feature and advantage of the present invention is the ability of such a system and method to incorporate an alternate configuration, wherein sensor units can be adapted for fixed installation in selected, generally permanent positions.

Yet another feature and advantage of the present invention is the ability of such a system and method to enable flexible adjustment of sensory components for optimization of the obstacle detection area.

Still another feature and advantage of the present invention is the ability of such a system and method to enable cost effective ground movement collision avoidance for existing and/or new vehicles, aircraft, airport terminal shuttles, boats, trains, material transport trucks, big rigs, fork lifts, loading docks, and/or any other moving object.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a cross-sectional view of a sensor module, according to the preferred embodiment of the present invention, showing the clamping mechanism in a disengaged position;

FIG. 2 is an elevational view of a receiving unit, according to the preferred embodiment of the present invention;

FIG. 3 is a cross-sectional view of a sensor module, according to an alternate embodiment of the present invention, showing the clamping mechanism in a partially engaged position; and

FIG. 4 is an elevational view of the control panel of the sensor module shown in FIG. 3, taken along line IV-IV.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

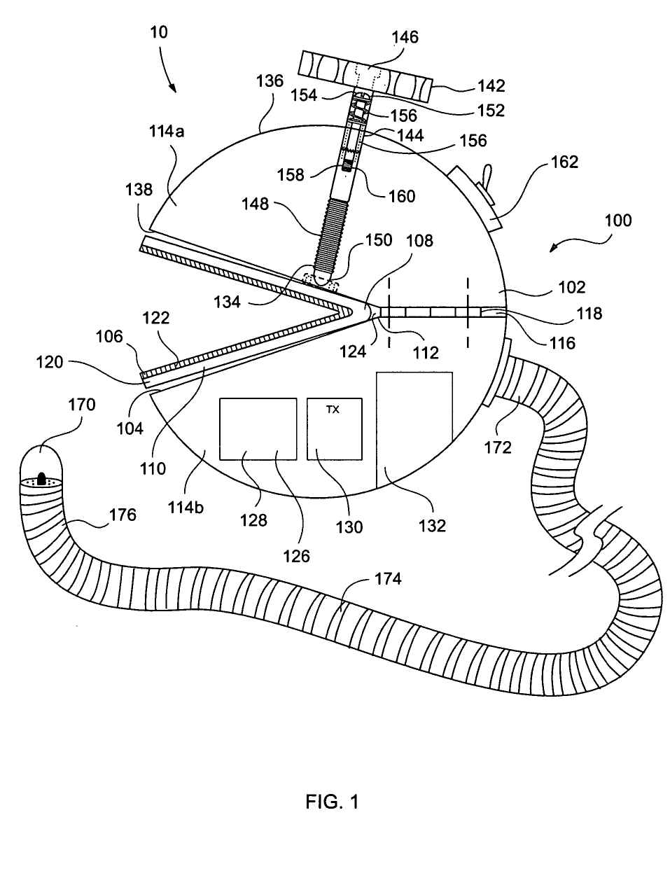

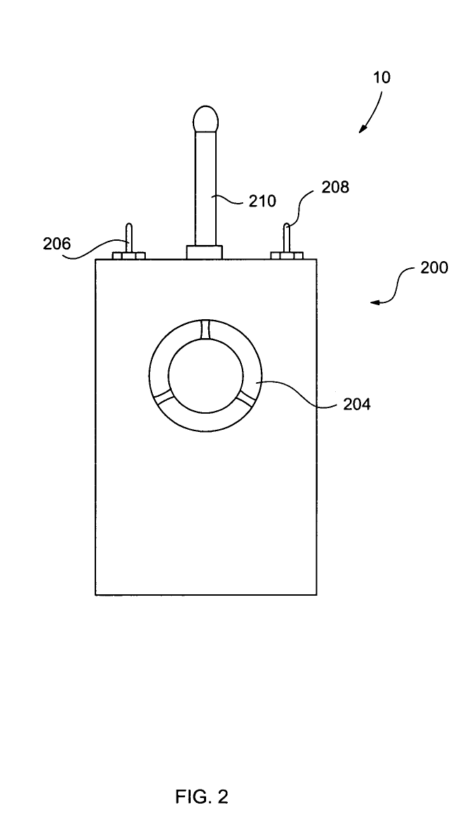

Referring now to FIGS. 1-2, the present invention in the preferred embodiment is sensor system 10, and method thereof, comprising plurality of modular sensor components 100 and remote receiver unit 200. It is important to understand that the present invention is suitable for utilization in any environment on any type of moving object wherein advance warning of potential collision and/or contact with an obstacle would be beneficial; therefore, while the system and method of the present invention is described conveniently with the preferred utilization as an aircraft ground movement safety systems, it is not limited to application or implementation with only such vehicles or apparatus. Further, while the preferred embodiment describes a modular sensor component 100, sensor system 10 is not intended to be limited to modular implementation. That is, although modular implementation is preferred for a plurality of reasons as noted herein, generally permanent or fixed installation of an appropriately configured sensor or sensors could be alternately utilized in lieu of, or in combination with, modular implementation, wherein although environmental adaptability would be generally more limited than with full modular implementation, the overall functionality of sensor system 10 and method thereof would remain, and remote receiver unit 200 would continue to warn of potential obstacles.

Preferably, each sensor module 102 of plurality of modular sensor components 100 is generally spherically-shaped with generally wedge-shaped aperture 104 defined therein. It is recognized that, although the generally spherical shape of sensor module 102 is preferred, other shapes could be utilized to define sensor module 102 without departing from the intended scope of the present invention. In the preferred configuration, wedge-shaped aperture 104 is adapted to carry generally triangular-shaped clamping structure 106, wherein base 108 of V-shaped cross-section 110 of clamping structure 106 is positioned proximate to base point 112 of wedge-shaped aperture 104. Sensor module 102 is preferably comprised of two halves 114a and 114b, wherein the proximal relationship of halves 114a and 114b defines the generally spherical shape preferred for sensor module 102, and wherein contact region 116 between halves 114a and 114b is preferably positioned proximate to base point 112 of wedge-shaped aperture 104. Preferably, contact region 116 contains connecting material 118, wherein connecting material 118 preferably intersects with base 108 of V-shaped cross-section 110 of clamping structure 106. In the preferred embodiment, clamping structure 106 comprises outer material element 120 and inner material element 122, wherein outer material element 120 and connecting material 118, together, define generally Y-shaped cross section 124. It should be readily recognized by one skilled in the art that although the V-shaped cross-section 110 is the preferred shape for clamping structure 106, clamping structure 106 could define other shapes, such as, for exemplary purposes only, rectangular, wherein sensor module 102 could be configured to enable clamping onto surfaces of virtually any shape and/or thickness, such as the front edge of an airplane, a wheel, a door, or any other partially peninsular component of a vehicle or structure wherein access to two opposing surfaces is possible.

Sensor module 102 preferably serves as a housing for sensory electronics 126, wherein sensory electronics 126 preferably comprise sensor unit 128, transmitter 130, and power source 132. Sensor unit 128 is preferably an ultrasonic Doppler transducer capable of transmitting and receiving ultrasonic information, wherein the frequency of the waves generated thereby changes as the waves echo from remote objects. That is, as sensor 170 moves closer to an obstacle, the frequency of the echo increases due to the Doppler effect. The distance from sensor 170 to the detected obstacle is proportional to the shift in frequency, or Doppler effect, thus enabling notification as a particular distance is approached or exceeded. Although it is preferred that sensor unit 128 is an ultrasonic Doppler sensor, other sensors could alternately be utilized such as, for exemplary purposes only, infrared, vision sensors, microwave based Doppler devices, and/or a combination thereof, wherein the theoretical basis for estimating the distance from sensor 170 to a detected obstacle would vary depending upon the type of sensor utilized, as would the accuracy of the estimate pursuant to the suitability of the sensor methodology to the environmental conditions.

Transmitter 130 is preferably a radio frequency (rf) transmitter capable of wireless transmission of signals to remote receiver unit 200. Although it is preferred that transmitter 130 is an rf transmitter, other types of wireless transmission platforms could be utilized such as, for exemplary purposes only, infrared signal communication platforms. Power source 132 is preferably a battery pack, wherein any suitable type of single or multi-cell, rechargeable and/or single-life energy source could be incorporated. Preferably, sensor unit 128, transmitter 130 and power source 132 are preferably retained within second half 114b of sensor module 102, wherein each component of sensory electronics 126 is accessible within sensor module 102 in order to enable adjustment thereto and/or replacement thereof.

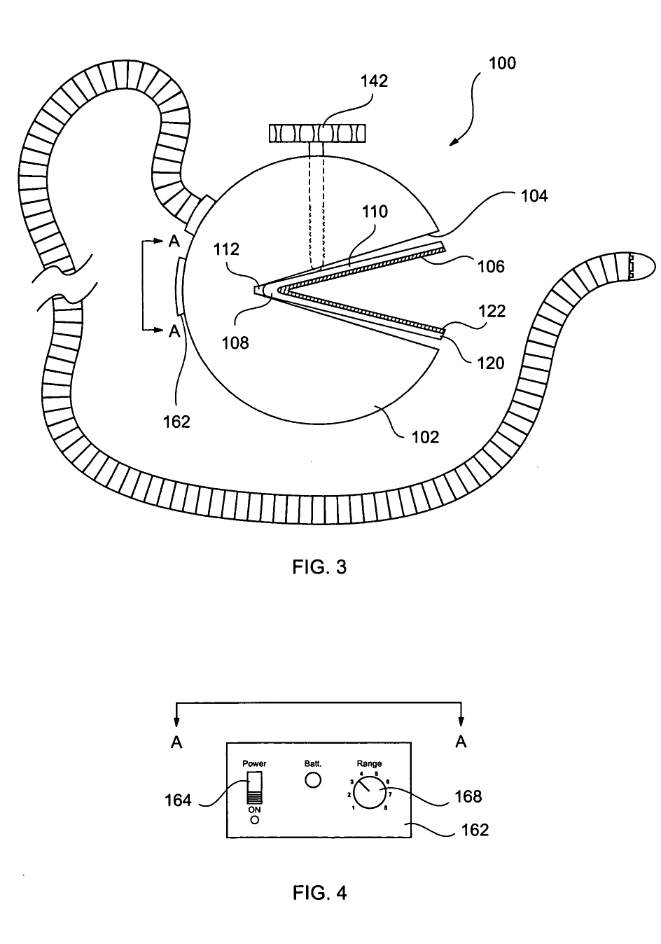

Referring now to FIG. 3 and FIG. 4, sensor module 102 preferably comprises control panel 162, wherein control switch 164, battery status indicator 166 and range selector 168 are preferably provided. The positional placement for control panel 162 on sensor module 102 is specifically not limited, and control panel 162 could be located at any accessible location, as shown in FIG. 3, on or adjacent to sensor module 102, wherein control panel 162 could be hard-wired or wireless. Preferably, range selector 168 enables user selectivity of distance-to-impact notification parameters for modular sensor system 10.

Referring again to FIG. 1, first half 114a of sensor module 102 preferably has clamping tunnel 134 defined therethrough, wherein clamping tunnel 134 preferably extends from outer surface 136 of sensor module 102 to inner surface 138 of wedge-shaped aperture 104. Clamping tunnel 134 is preferably dimensioned to enable functional positioning of module clamping system 140 essentially therewithin. The positioning of clamping tunnel 134 could be varied from the preferred depiction of FIG. 1, wherein one such alternate placement is depicted in FIG. 3.

In the preferred form, module clamping system 140 comprises clamping knob 142 and generally elongated member 144, wherein first end 146 of generally elongated member 144 is preferably centrally secured within clamping knob 142. It should be recognized by one skilled in the art that clamping knob 142 and generally elongated member 144 could be integrally formed, or that generally elongated member 144 could be welded or otherwise affixed to an exterior surface of clamping knob 142 in lieu of being secured therewithin. In the preferred form, generally elongated member 144 has threading serrations 148 defined proximate to second end 150 thereof, and clutching mechanism 152 provided therein.

Preferably, clutching mechanism 152 comprises clutch screw 154 and coil spring 156, wherein clutching serrations 158 are preferably defined proximate to distal end 160 of clutch screw 154. This preferred clutching mechanism 152 of module clamping system 140 enables installation of sensor module 102 without risk of damage to the underlying mounting structure from over-tightening. That is, rotational adjustment of clamping knob 142 engages clutching mechanism 152, whereupon advancement of generally elongated member 144 within clamping tunnel 134 enables the application of force to outer material element 120 and inner material element 122, whereby clamping structure 106 is contracted and wedge-shaped aperture 104 is narrowed, as depicted in FIG. 3. The preferred incorporation of clutching mechanism 152 into module clamping system 140 ensures that the force delivered to the mounting surface is essentially limited to that necessary for holding sensor module 102 in place, thus enabling utilization of modular sensor components 100 on any trailing edge structure, i.e. aluminum, composite and fabric without damage thereto. It should be noted that although module clamping system 140 is particularly suited for utilization on a trailing edge structure, it is anticipated within the scope of the invention as described herein that module clamping system 140 could be secured on any partially extending structural component of any type of vehicle or building.

The preferred structural components of module clamping system 140 also serve to reduce and/or essentially eliminate potential damage to the underlying mounting surface. The preferred material for inner material element 122 and connecting material 118 is soft sprung aluminum, wherein flexibility and strength enable consistent delivery of appropriate force while retaining at least a minimum of resiliency. The preferred material for outer material element 120 is generally soft, essentially tacky rubber lining, wherein a non-marring grip-type effect is delivered to the mounting surface. One skilled in the art should readily recognize that while the foregoing are the preferred materials for inner material element 122, connecting material 118, and outer material element 120, other materials could be alternately utilized, wherein the appropriate features and performance characteristics could be delivered thereby.

Additionally, magnet 190 could be included on sensor module 102, as depicted in FIG. 3, thereby facilitating magnetic mounting onto any appropriate surface, as an alternative to clamp-style mounting.

Preferably, sensing extension member 172 extends from second half 114b of sensor module 102 to sensor 170, thereby linking sensor unit 128 and sensor 170. As depicted in FIG. 3, however, sensing extension member 172 could extend from first half 114a of sensor module 102 in an alternate configuration. In the preferred embodiment, sensing extension member 172 is capable of flexible positioning; that is, sensing extension member 172 preferably has an elongated tubular shape with a plurality of essentially concentric support rings 174 defined thereon. The preferred structure of sensing extension member 172 enables adjustable direction of sensor 170, wherein sensor 170 is preferably positioned proximate distal end 176 of sensing extension member 172. The preferred ability for selective positioning of sensor 170, realized from the structural features of sensing extension member 172, provides for maximum versatility in placement of modular sensor component 100 on a support structure, such as an airplane. Thus, sensing extension member 172 enables sensor 170 to target any sector of the three-dimensional surroundings, irrespective of relative placement of modular sensor component 100 on a selected underlying mounting structure; for example, modular sensor component 100 could be secured to the front edge of the right wing of an aircraft and sensor 170 could be directed toward the front or rear of the aircraft, toward the left or right of the aircraft, or even above or below the aircraft.

Referring now to FIG. 2, remote receiving unit 200 is preferably adapted to wirelessly receive signals from transmitter 130. Preferably, remote receiving unit 200 comprises vibrational mechanism 202 (not shown), audible alarm 204, alarm reset switch 206, operational switch 208 and antenna 210. Audible alarm 204 is preferably capable of delivering a 105 decibel warning tone. Further, in the preferred embodiment, remote receiving unit 200 includes adaptive exterior structures to enable secure and removable placement on a belt of a user, such as a tug operator. Alternatively, case 212 (not shown) could be provided to receive remote receiving unit 200 and enable hands-free utilization thereof.

In the preferred use, a plurality of sensor modules 102 is secured to the outboard trailing edges of an aircraft's ailerons, elevators and rudder after landing and prior to ground movement. Each sensing extension member 172 is manipulated to enable maximum target detection relative to anticipated movement of the aircraft. A tug operator carries remote receiving unit 200, selecting the preferred distance-to-impact notification appropriate for the conditions, for example, between essentially zero to five feet. Upon sensing an obstacle, sensor unit 128 signals transmitter 130, wherein a signal is transmitted to remote receiving unit 200. Preferably, as the selected distance-to-impact range is approached, an audible warning signal is emitted by audible alarm 204 and vibrational mechanism 202 is activated. Further, as the distance-to-impact decreases, additional audible signals are emitted by audible alarm 204, wherein each signal preferably graduatedly increases in decibels, essentially progressing from a warning signal, or chirp, to a steady, emergency alarm. Thus, automated advance warning is provided to the tug driver regarding approaching obstacles, such as hangar walls, doors, aircraft, and ground personnel.

In an alternate embodiment, modular sensory system 10 could utilize transmitting handwands, such as those described in U.S. Pat. No. 6,294,985B1, wherein manual alarm activation could be enabled. That is, handwand operators could manually signal remote receiving unit 200 to notify the tug operator of an impending collision.

In another alternate embodiment, sensor module 102 could include a strap to enable hands-free support thereof following removal from a support structure.

In another alternate embodiment, each sensor module 102 could be placed on a stationary structure, wherein the potential obstacle could be moving.

In another alternate embodiment, sensor units could be configured to enable fixed, or essentially permanent installation, wherein sensing extension member 172 could continue to provide a measure of environmental adaptability.

In another alternate embodiment, functional sensory support components of sensor module 102, including but not limited to sensor 170, transmitter 130 and power source 132, could be fixedly installed on or in an aircraft, such as, for exemplary purposes only, proximate to a wing edge or to the exterior of the fuselage, or in or on any other appropriate vehicle seeking to avoid potential obstacles.

In another alternate embodiment, modular sensory system 10 could be utilized on an airport passenger shuttle vehicle, such as shuttles operating between remotely located passenger terminals.

In another alternate embodiment, sensory electronics 126 could be retained within first half 114a of sensory module 102 in lieu of second half 116, or some combination thereof.

In another alternate embodiment, modular sensor component 100 could be formed without sensing extension member 172, wherein sensor 170 could be essentially fixed within or proximate to sensor module 102.

In another alternate embodiment, sensing extension member 172 could have a predefined projection or extension angle relative to sensor module 102, wherein sensing extension member 172 could be essentially rigid.

In yet another alternate embodiment, sensing extension member 172 could be motorized, wherein a plurality of repetitious patterns of movement thereof could be selected in order to scan a given target area, or movement of sensing extension member 172 could be random.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A modular sensor component for removable placement on an object and for sensing relative position thereof, comprising:
a sensor,
a mounting means,
a transmitter,
a power source, and
a housing, wherein said mounting means removably secures said housing to the object, wherein said sensor determines the relative position of the object, and wherein said transmitter emits a signal based upon the relative position of the object.

2. The modular sensor component of claim 1, wherein said mounting means comprises a clutching clamp pressure delivery system.

3. The modular sensor component of claim 1, further comprising an elongated arm, wherein said sensor is carried proximate to a distal end of said elongated arm.

4. The modular sensor component of claim 3, wherein said elongated arm is substantially flexible and capable of maintaining a selected positional arrangement.

5. The modular sensor component of claim 1, wherein said sensor has range selection capabilities, wherein said signal is transmitted by said transmitter upon detection of an obstacle within said selected range of the object.

6. The modular sensor component of claim 1, wherein said sensor utilizes ultrasonic Doppler techniques for sensing relative position of the object.

7. The modular sensor component of claim 1, wherein said housing is generally spherically-shaped, and wherein said mounting means defines a generally wedge-shaped aperture therein.

8. The modular sensor component of claim 1, wherein said housing further comprises at least one component selected from the group of: a control panel, a power switch, and a power source status indicator.

9. The modular sensor component of claim 2, wherein said clutching clamp pressure delivery system comprises a clamping tunnel defined through said housing, and an elongated clamping member carried generally within said clamping tunnel, wherein said elongated clamping member engages a clutching mechanism comprising a clutch screw and a coil spring, and wherein said housing further comprises a compression aperture adapted to deliver pressure upon engagement with said elongated clamping member.

10. The modular sensor component of claim 9, wherein said compression aperture carries a generally conformable lining comprising aluminum.

11. The modular sensor component of claim 10, wherein said generally conformable lining has a rubberized compression delivery surface.

12. The modular sensor component of claim 9, wherein said compression aperture is generally wedge-shaped.

13. The modular sensor component of claim 1, wherein said housing carries a strap.

14. A collision avoidance system, comprising:
a plurality of sensor components, said plurality of sensor components capable of temporary placement and utilization for detection of an obstacle and for transmitting a signal in response to said detection, and
a receiver unit, said receiver unit remote to said plurality of sensor components, said receiver unit having an alert mechanism, and said receiver unit adapted to receive said signal from said plurality of sensor components, wherein said alert mechanism is activated upon receipt of said signal from a sensor component of said plurality of sensor components.

15. The collision avoidance system of claim 13, wherein said alert mechanism is graduated and generally related to an estimated distance-to-impact of the detected obstacle.

16. The collision avoidance system of claim 13, wherein said alert mechanism comprises an audible notification.

17. The collision avoidance system of claim 13, wherein said alert mechanism comprises a vibrational notification.

18. The collision avoidance system of claim 13, wherein said receiver unit further comprises at least one component selected from the group of: a reset switch, an operational control switch, and an antenna.

19. The collision avoidance system of claim 13, wherein said receiver unit is belt-wearable.

20. The collision avoidance system of claim 13, further comprising a case, said case adapted to receive said receiver unit.

21. The collision avoidance system of claim 13, further comprising a handwand, said handwand comprising a signal transmitter, wherein said receiver unit is adapted to receive said signal from said handwand.

22. A method of sensing relative position of an object, comprising the steps of:
a) obtaining a modular sensory unit comprising a sensor, a mounting mechanism, a transmitter, a power source, and a housing;
b) removably securing said housing to the object;
c) selecting a relative position tolerance limit;
d) activating said sensor to determine the relative position of the object; and
e) if said determination exceeds said relative position tolerance limit, transmitting a signal in response to said determination.

23. The method of claim 22, further comprising the steps of:
f) removing said housing from the object;
g) removably securing said housing to a second object;
h) repeating steps c-e.

24. A method of avoiding a collision, comprising the steps of:
a) temporarily placing a modular sensor and transmitter component to a structure;
b) obtaining a receiver and alert notification device;
c) detecting an obstacle with said sensor;
d) determining the distance between the obstacle and the structure;
e) transmitting a signal in response to said determination;
f) receiving said signal with said receiver; and
g) generating an alert notification in response to said signal.

25. The method of claim 24, wherein the structure has mobility.

26. The method of claim 24, wherein the obstacle has mobility.

27. A clutched clamping device for removably securing an object to a mounting structure, comprising:
a clamping tunnel defined through said object;
an elongated clamping member carried generally within said clamping tunnel;
a clutching mechanism comprising a clutch screw and a coil spring; and
a compression aperture defined within said object,
wherein rotational adjustment of said elongated clamping member engages said clutching mechanism, and wherein said compression aperture delivers pressure to the mounting structure upon engagement with said elongated clamping member.

28. The modular sensor component of claim 1, further comprising a receiver, said receiver configured to remotely receive said signal from said transmitter.

29. The modular sensor component of claim 28, wherein said transmitter is a radio frequency transmitter.

30. The modular sensor component of claim 1, wherein said wedge-shaped aperture carries a generally triangular-shaped clamping structure comprising an inner material element and an outer material element.

31. The modular sensor component of claim 30, wherein said inner material element is soft sprung aluminum.

32. The modular sensor component of claim 30, wherein said outer material element is generally soft, essentially tacky rubber.

33. The modular sensor component of claim 4, wherein said elongated arm is generally tubular-shaped and comprises a plurality of essentially concentric support rings diametrically defined along the length thereof.

34. The modular sensor component of claim 3, further comprising a motorized movement mechanism for said elongated arm.

35. The modular sensor component of claim 34, wherein a directional pattern for said motorized movement of said elongated arm is programmable.

36. A sensory system for installation on an aircraft, for sensing relative position thereof during ground movement and for warning a ground movement operator of potential collision, comprising:
a receiver, said receiver carried remotely from the aircraft by the ground movement operator,
a sensor,
a mounting mechanism,
a transmitter,
a power source, and
a housing, wherein said mounting mechanism secures said housing to the aircraft, wherein said sensor determines the relative position of the aircraft, wherein said transmitter emits a signal based upon the relative position of the aircraft and wherein said signal is received by said receiver.

37. The sensor system of claim 36, further comprising an elongated arm, wherein said sensor is carried proximate to a distal end of said elongated arm.

38. The modular sensor component of claim 36, wherein said sensor utilizes ultrasonic Doppler techniques for sensing relative position of the aircraft.

39. An on-board obstacle detection and remote warning system for an airplane, comprising:
a plurality of sensor components, said plurality of sensor components placed and utilized for detection of an obstacle and for transmitting a signal in response to said detection, and
a receiver unit, said receiver unit remote to the airplane, said receiver unit having an alert mechanism, and said receiver unit adapted to receive said signal from said plurality of sensor components, wherein said alert mechanism is activated upon receipt of said signal from a sensor component of said plurality of sensor components.

40. The modular sensor component of claim 1, wherein said mounting means comprises a magnet, said magnet carried by said housing.
